(19) United States
(12) Patent Application Publication
(10) Pub. No.: US 2019/0305638 A1
(43) Pub. Date: Oct. 3, 2019

(54) WHEEL HUB MOTOR

(71) Applicants: RICHARD CHI-HSUEH, (US); CHUNG-YEH HSU, NEW TAIPEI CITY (TW); TZU-CHIN HSU, NEW TAIPEI CITY (TW); YIE-YEH HSU, NEW TAIPEI CITY (TW)

(72) Inventors: RICHARD CHI-HSUEH, SAN DIEGO, CA (US); CHUNG-YEH HSU, NEW TAIPEI CITY (TW); TZU-CHIN HSU, NEW TAIPEI CITY (TW)

(21) Appl. No.: 16/364,342

(22) Filed: Mar. 26, 2019

Related U.S. Application Data
(60) Provisional application No. 62/650,398, filed on Mar. 30, 2018.

(51) Int. Cl. H02K 7/18; H02K 16/04; H02K 21/14; H02K 1/14; B60L 15/20; H02K 11/042

(52) U.S. Cl. CPC H02K 7/1846; H02K 16/04; H02K 21/145; B60L 2220/50; B60L 15/20; H02K 11/042; B60L 2220/44; H02K 1/145

(57) ABSTRACT

A wheel hub motor is disclosed herein for installation in a wheel of a vehicle. It comprises a ring-shaped casing having a first end and a second end, a stator unit disposed in the ring-shaped casing and having a stator base and a stator ring disposed on the stator base, a rotor unit disposed in the ring-shaped casing and having a rotor base connected at the second end of the ring-shaped casing and plural permanent magnetic sheets disposed on the rotor base for corresponding to the stator ring, a shell cover connected at the first end of the ring-shaped casing, and a major axis for connecting a car body of the vehicle.

### BACKGROUND OF THE INVENTION

### 1. Field of the Invention

The present invention relates to a wheel hub motor which comprises plural permanent magnetic sheets on a rotor base corresponding to a stator ring so as to increase the sensing area of a stator unit and a rotor unit, improve the magnetic flux and the magnetic effect and generate large torque and horsepower.

### 2. Description of Related Art

The drive motors of the conventional hybrid electric vehicles and electric vehicles are generally assembled in the wheel frames of the wheels, and thus such drive motors are also referred to as hub motors or rim motors. For instance, the US patent US2005/0045392, published on 3 Mar. 2005, has disclosed in-wheel electric motors; the US patent US2012/0302390, published on 29 Nov. 2012, has disclosed a bidirectional hub motor with unidirectional two-speed output; the China patent CN105882384A, published on 24 Aug. 2016, has disclosed a motor hub; and the China patent CN101110536B, issued on 1 Jun. 2011, has disclosed a rim motor with automatic speed changing function. The drive motors of the abovementioned patents disposed in the wheel frames mainly comprises a stator unit, a rotor unit and an axle. Each of a plural silicon steel sheets of the stator unit is wound with plural coils. A rotor casing of the rotor unit defines an internal space, and the stator unit is accommodated in the internal space. Plural magnets are arranged at intervals on a lateral wall of the rotor casing to surround peripheries of the plural silicon steel sheets of the stator unit and connect the rotor casing to a wheel frame. The axle is inserted into the stator unit and protruded from the rotor casing to connect a car body of a mobile vehicle. Accordingly, when the coils of the stator unit are energized and interact with the plural magnets of the rotor unit, the rotor casing of the rotor unit rotates relative to the stator unit, thereby making the wheel frame of the wheel combined with the rotor casing rotate to drive the mobile vehicle to move.

However, the conventional hub motors mentioned above have disadvantages as following:

1. The lateral wall of the rotor casing has limited area and space for assembling the plural magnets, so the plural magnets are small and thin, and the sensing area between the plural magnets and the plural silicon steel sheets is small, resulting in reduced output horsepower and torque.

2. The plural silicon steel sheets provided on the stator unit must be locked and fixed to the stator unit one by one with a screw or the like, so that assembly is quite time-consuming

3. The plural silicon steel sheets are spaced apart from each other. The increased air spaces reduce the magnetic flux as well as the magnetic effect, resulting in a loss of the operating efficiency of the hub motor.

### SUMMARY OF THE INVENTION

In view of the above-mentioned problems, the object of the present invention is to provide a wheel hub motor which comprises plural permanent magnetic sheets on a rotor base corresponding to a stator ring so as to increase the sensing area of a stator unit and a rotor unit, improve the magnetic flux and the magnetic effect and generate large torque and horsepower.

Disclosed herein is a wheel hub motor for installation in a wheel of a vehicle. It mainly comprises a ring-shaped casing having a first end and a second end, a stator unit disposed in the ring-shaped casing and having a stator base and a stator ring disposed on the stator base, a rotor unit disposed in the ring-shaped casing and having a rotor base connected at the second end of the ring-shaped casing and plural permanent magnetic sheets disposed on the rotor base for corresponding to the stator ring, a shell cover connected at the first end of the ring-shaped casing, and a major axis for connecting a car body of the vehicle.

Accordingly, the present invention increases the sensing area of the stator ring and the plural permanent magnetic sheets by the design of the plural permanent magnetic sheets on the rotor base corresponding to the stator ring, and improves the magnetic flux and the magnetic effect by plural minimal air spaces of the stator ring, which achieve the effects of providing large torque and horsepower, effectively saving energy and improving the endurance of the wheel hub motor.

### BRIEF DESCRIPTION OF THE DRAWINGS

FIG. 1 is a first explosion diagram showing a first embodiment for a wheel hub motor according to the present invention;

FIG. 2 is a second explosion diagram showing the first embodiment for a wheel hub motor according to the present invention;

FIG. 3 is a third explosion diagram showing the first embodiment for a wheel hub motor according to the present invention;

FIG. 4 is a stereogram showing a first embodiment for a wheel hub motor according to the present invention;

FIG. 5 is a cross-sectional view showing a first embodiment for a wheel hub motor according to the present invention;

FIG. 6 is a perspective view showing a first embodiment for a wheel hub motor in use according to the present invention;

FIG. 7 is an explosion diagram showing a second embodiment for a wheel hub motor according to the present invention;

FIG. 8 is a cross-sectional view showing a second embodiment for a wheel hub motor according to the present invention;

FIG. 9 is a perspective view showing a second embodiment for a wheel hub motor in use according to the present invention.

### DETAILED DESCRIPTION OF THE PREFERRED EMBODIMENT

Hereinafter, an exemplary embodiment of the present invention will be described in detail with reference to the accompanying drawings.

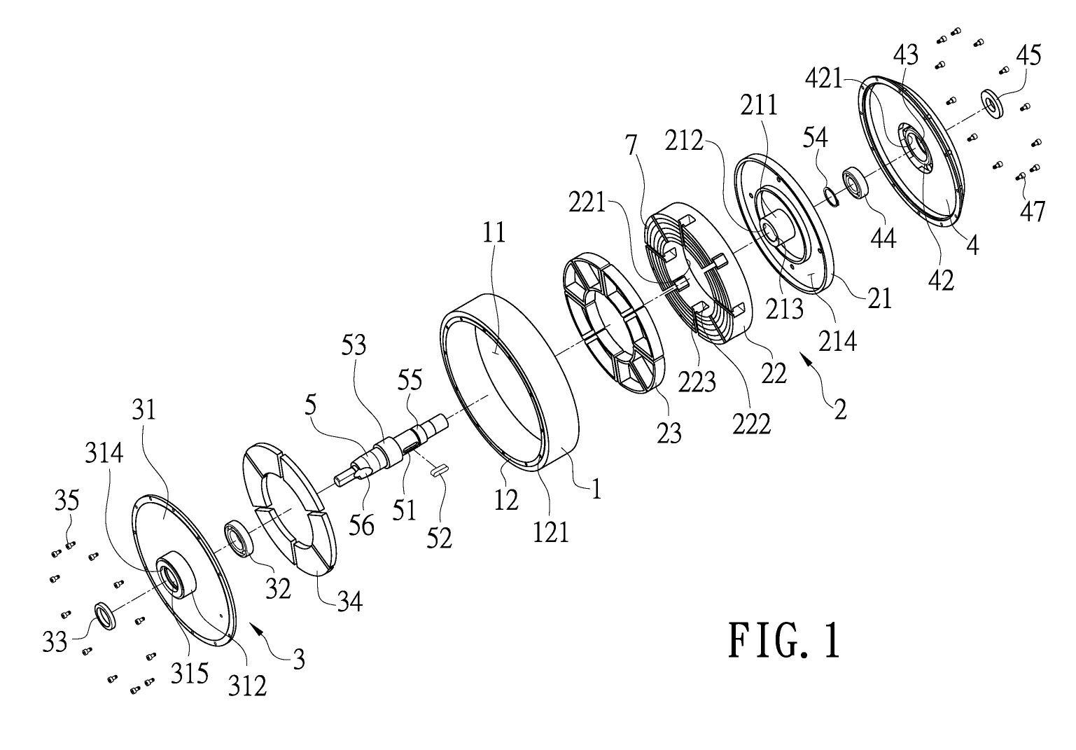

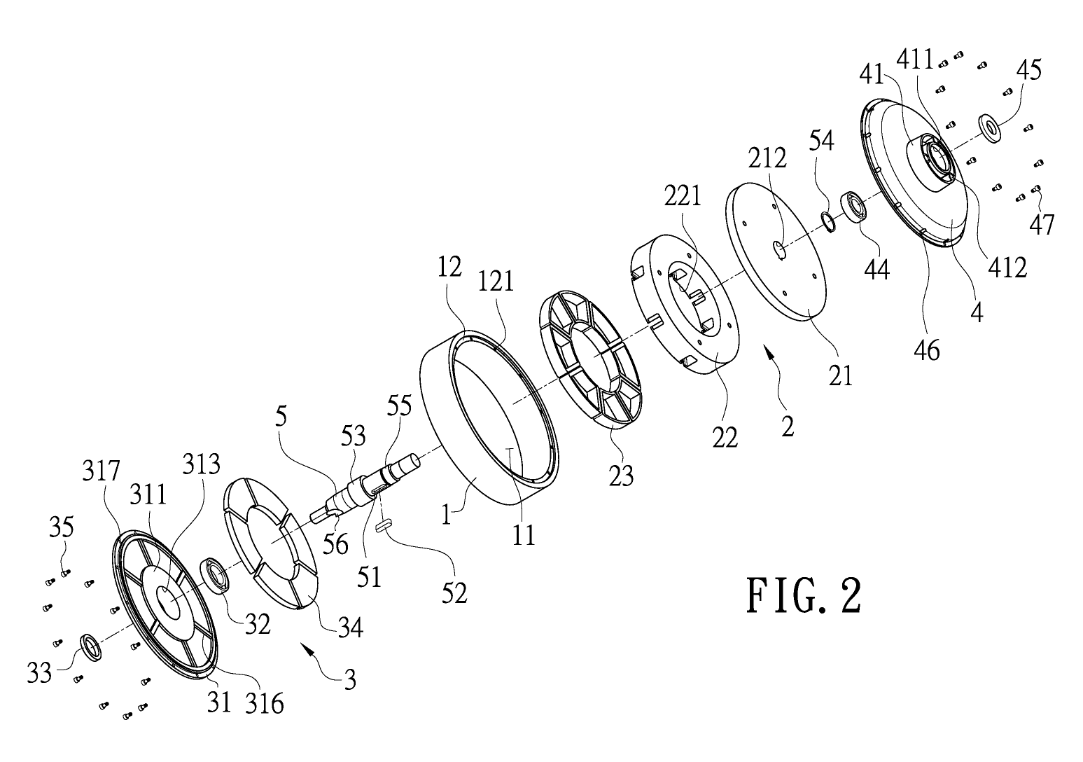

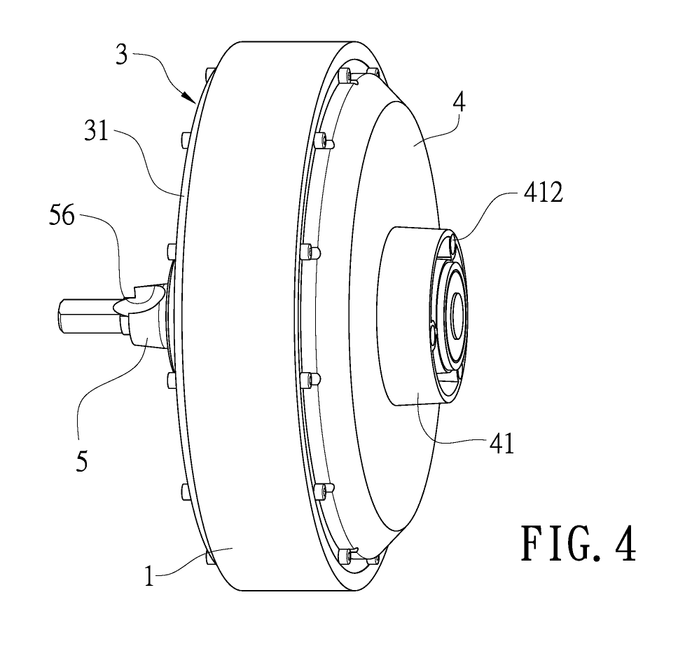

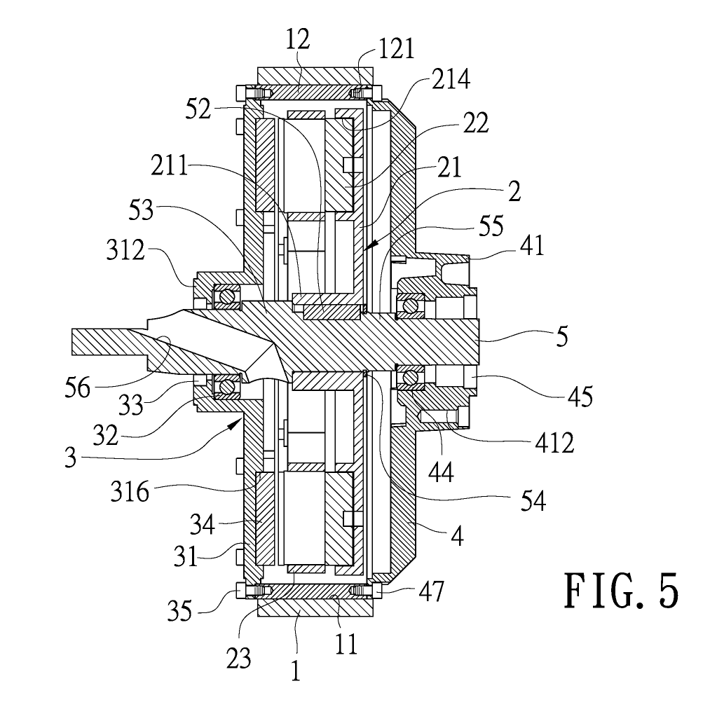

First, referring to FIG. 1 to FIG. 5, a first embodiment for a wheel hub motor according to the present invention comprises is disclosed. The wheel hub motor comprises a ring-shaped casing (1), a stator unit (2), a rotor unit (3), a shell cover (4) and a major axis (5).

The ring-shaped casing (1) comprises a first end, a second end opposite to the first end, a cavity (11) at a center thereof and a fixing ring (12) on a wall of the cavity (11) to be connected to the wall of the cavity (11). The fixing ring (12) has a first end extended from the first end of the ring-shaped casing (1), a second end extended from the second end of the ring-shaped casing (1), and plural lock holes (121) respectively disposed at the first end and the second end.

The stator unit (2) is accommodated in the cavity (11) of the ring-shaped casing (1) and comprises a stator base (21), a stator ring (22) and plural coils (23). The stator base (21) is shaped as a disc and has a first side, a second side opposite to the first side, a shaft sleeve (211) at a center of the second side thereof, a shaft hole (212) at a center of the shaft sleeve (211), a first positioning part (213) on a wall of the shaft hole (212) and an engaging slot (214) surrounding the shaft sleeve (211) at the second side. The stator ring (22) is formed by a wound silicon steel sheet tightly integrated into one and locked to the stator base (21) by plural fasteners, e.g. screws. The stator ring (22) has a first side correspondingly engaged with the engaging slot (214) of the stator base (21), a second side opposite to the first side, a through hole (221) at a center of the stator ring (22) and concentric with the shaft hole (212) of the stator base (21), plural coil holes (222) arranged at intervals in the stator ring (22), and plural ditches (223) disposed at the second side for respectively corresponding to the plural coil holes (222) and communicating with the plural coil holes (222). Furthermore, the two adjacent coil holes (222) are wrapped around with one of the plural coils (23), and the two adjacent coils (23) are connected in series.

The rotor unit (3) comprises a first side, a second side opposite to the first side, a rotor base (31) shaped as a disc, at least one bearing (32), a sealing ring (33), plural permanent magnetic sheets (34) and plural fasteners (35). The rotor base (31) has a first side for covering at the second end of the ring-shaped casing (1), a second side opposite to the first side, a first assembling part (311) at the center of the first side, a second assembling part (312) at the center of the second side, a first assembling slot (313) at a center of the first assembling part (311), a second assembling slot (314) at a center of the second assembling part (312), a shaft hole (315) at the center thereof for penetrating the first assembling part (311) and the second assembling part (312) and plural fixing slots (316) arranged at intervals on the rotor base (31) and concentric with the shaft hole (315) to be correspondingly and respectively assembled with the plural permanent magnetic sheets (34). The at least one bearing (32) is accommodated in the first assembling slot (313). The sealing ring (33) is engaged with the second assembling slot (314). The plural permanent magnetic sheets (34) disposed on the first side of the rotor base (31) are accommodated in the cavity (11) of the ring-shaped casing (1) for corresponding to the stator ring (22). Additionally, a periphery of the rotor base (31) is provided with plural lock holes (317) for corresponding to the plural lock holes (121) at the second end of the fixing ring (12). The plural fasteners (35), e.g. screws, are used to lock the rotor base (31) to the ring-shaped casing (1) by inserting into the plural lock holes (317) of the rotor base (31) and the plural lock holes (121) of the ring-shaped casing (1) for fixation.

The shell cover (4) comprises a first side, a second side opposite to the first side for covering at the first end of the ring-shaped casing (1), a third assembling part (41) at a center of the first side and having a third assembling slot (411) at its center and plural lock bores (412) at a periphery of the third assembling slot (411), a fourth assembling part (42) at a center of the second side and having a fourth assembling slot (421) at its center, a shaft hole (43) at a center of the second side, at least one bearing (44) accommodated in the fourth assembling slot (421), a sealing ring (45) engaged with the third assembling slot (411), plural lock holes (46) at a periphery of the shell cover (4) for corresponding to the plural lock holes (121) at the first end of the fixing ring (12) of the ring-shaped casing (1), and plural fasteners (47) inserted into the plural lock holes (46) and the plural lock holes (121) so as to lock the shell cover (4) to the ring-shaped casing (1) for fixation.

The major axis (5) is accommodated in the cavity (11) of the ring-shaped casing (1) and has a first end and a second end opposite to the first end. The first end of the major axis (5) passes from the cavity (11) of the ring-shaped casing (1) through the shaft hole (212) of the stator base (21) and the shaft hole (43) of the shell cover (4) for connecting the at least one bearing (44) in the fourth assembling slot (421) and the sealing ring (45) in the third assembling slot (411). The second end of the major axis (5) passes from the cavity (11) of the ring-shaped casing (1) through the shaft hole (315) of the rotor base (31), the at least one bearing (32) in the first assembling slot (313) and the sealing ring (33) in the second assembling slot (314) and protrudes from the rotor base (31). The major axis (5) further comprises a second positioning part (51) corresponding to the first positioning part (213) on a wall of the shaft hole (212) of the stator base (21), a fixing element (52) for fixedly connecting the second positioning part (51) with the first positioning part (213) to fix the major axis (5) to the stator base (21), a first segment (53) having a first side and a second side opposite to the first side, a buckle ring (54) engaged with the first side of the first segment (53) and contacting the first side of the stator base (21) for positioning, a second segment (55) adjacent to the buckle ring (54) for contacting the at least one bearing (44) in the fourth assembling slot (421) of the shell cover (4) for positioning, and a cable outlet hole (56) formed lengthwise at the second end of the major axis (5). The first side of the first segment (53) contacts the shaft sleeve (211) on the second side of the stator base (21) for positioning and the second side of the first segment (53) contacts the at least one bearing (32) in the first assembling slot (313) of the rotor base (31) for positioning. The cable outlet hole (56) has one opening located in the cavity (11) of the ring-shaped casing (1) and the other opening located out of the rotor base (31) so that the plural coils (23) of the stator unit (2) pass through the cavity (11) and out of the cable outlet hole (56).

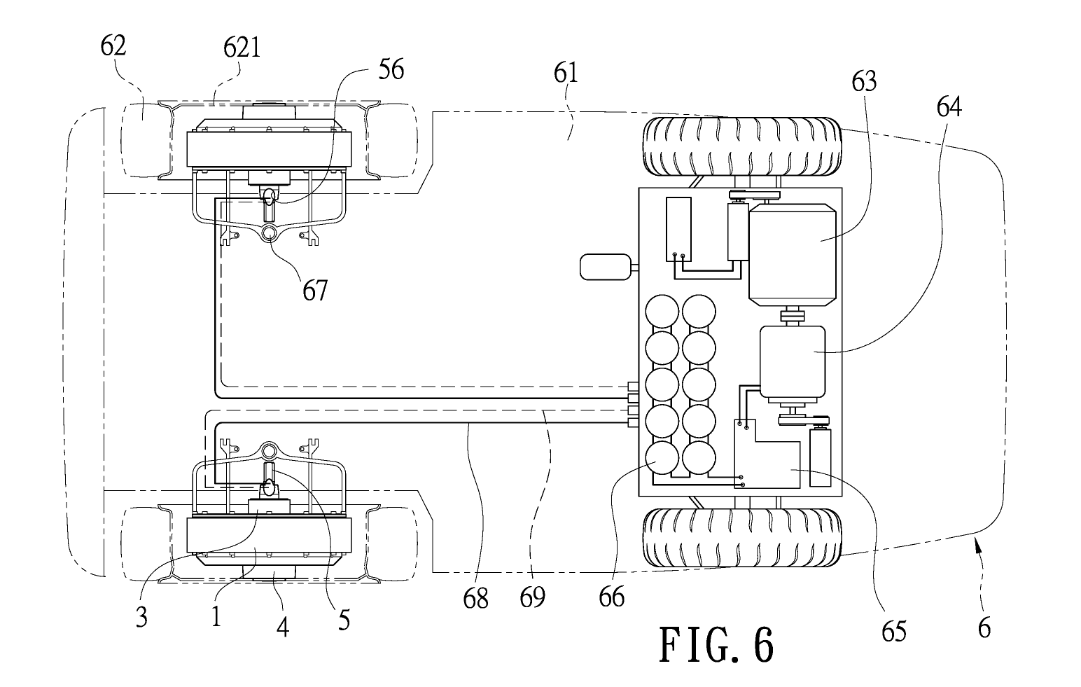

Referring to FIG. 6, in a practical use of the present invention, the wheel hub motor is applied to a vehicle (6). The vehicle (6) comprises a car body (61), four wheels (62) at two laterals of a front side and a rear side of the car body (61), a small ultra-high speed gasoline engine (63) disposed in the car body (61), an electricity generator (64) with high efficiency connected to the gasoline engine (63) in the car body (61), a power and motor controller (65) connected to the connected to the electricity generator (64) in the car body (61), and at least one capacitive battery (66) connected to the power and motor controller (65) in the car body (61) for storing large capacity power and fast charging and discharging. The power and motor controller (65) adjusts, rectifies, and stabilizes the high-voltage, high-current electric energy generated by the electricity generator (64) to the state that is suitable for the at least one capacitive battery (66) to store.

Two hub motors are applied to a vehicle (6) and respectively installed in the two wheels (62) at two laterals of the rear side of the car body (61). The second end of the major axis (5) of each of the two hub motors is assembled to a suspension holder (67) of the car body (61), and the two hub motors are respectively accommodated in wheel frames (621) of the two wheels (62). The plural lock bores (412) at a periphery of the third assembling slot (411) of the third assembling part (41) are correspondingly screwed to plural lock holes on the wheel frames (621) of the wheels (62) by plural fasteners, e.g. screws, so that the two hub motors are connected to the wheel frames (621) of the two wheels (62) for fixation. Then, the plural coils (23) of the stator unit (2) are pierced out of the cable outlet hole (56) of the major axis (5) for connecting the at least one capacitive battery (66) by at least one power cable (68) and connecting the power and motor controller (65) by a signal cable (69).

Accordingly, the small ultra-high speed gasoline engine (63) of the vehicle (6) drives the electricity generator (64) to generate high voltage and large current. The power and motor controller (65) adjusts, rectifies, and stabilizes the high-voltage, high-current electric energy generated by the electricity generator (64) to the state that is suitable for the at least one capacitive battery (66) to store. The capacitive battery (66) further transmits the electric energy to the plural coils (23) on the stator ring (22) that is assembled on the two wheels (62) at the rear side of the car body (61) through the power cable (68), so the plural coils (23) are energized and interact with the plural permanent magnetic sheets (34) disposed on the rotor base (31) to generate a rotating magnetic field. Hence, a rotating magnetic field generated between the plural permanent magnetic sheets (34) drives the rotor base (31) to rotate. At this time, the shell cover (4) connected to the rotor base (31) through the ring-shaped casing (1) is rotated with the rotor base (31), which also drives the wheel frames (621) of the two wheels (62) connected to the shell cover (4) to rotate. In this way, the hub motors drive the two wheels (62) at the rear side of the car body (61) to rotate and bring the vehicle (6) to move.

Due to the design of the plural permanent magnetic sheets (34) of the rotor unit (3) on the first side of the rotor base (31) corresponding to the stator ring (22) of the stator unit (2), the sensing area of the stator ring (22) and the plural permanent magnetic sheets (34) is increased to achieve large torque and horsepower. Furthermore, the stator ring (22) is made of a long silicon steel strip that is wound and tightly fixed into a ring body, so that the stator ring (22) has high structural strength after molding and can save time and increase convenience in assembly. Furthermore, only the second side of the stator ring (22) is provided with plural minimal ditches (223), which is beneficial to improve the magnetic flux and the magnetic effect. Therefore, in the case of an increase in the magnetic effect and an increase in the sensing area, the same electric voltage and current can be used to obtain several times of torque and horsepower, and the horsepower needed when starting and driving the vehicle (6) as well as the torque needed when climbing can be easily achieved to effectively save the energy, and the endurance of the vehicle (6) can be improved.

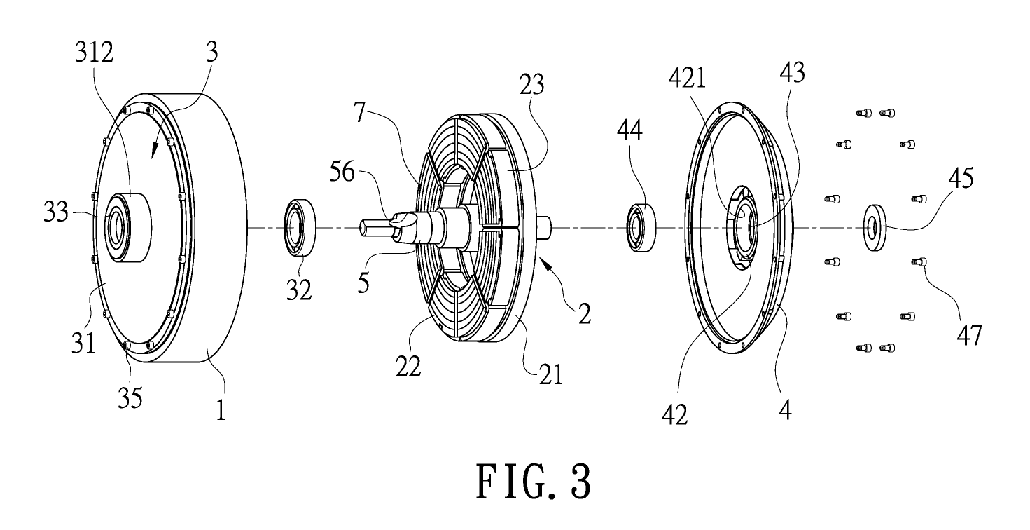

The wheel hub motor is further provided with at least one motor commutation control element (7) for connecting the power and motor controller (65) by the signal cable (69). Referring to FIG. 3, the at least one motor commutation control element (7) is a Hall element and engaged with a periphery of the stator ring (22) for detecting the change of the magnetic field strength of the rotor base (31) when rotating. Then, the detected signal is transferred to the power and motor controller (65) to adjust the voltage of the coils (23) on the stator ring (22). The motor commutation control element (7) can also be a magnetic commutation encoder or an optical commutation encoder and assembled to the major axis (5) and the rotor base (31) for detecting the rotating speed of the rotor base (31). The detected signal is transferred to the power and motor controller (65) to adjust the voltage of the coils (23) on the stator ring (22). In this way, the vehicle (6) can be operated smoothly and efficiently.

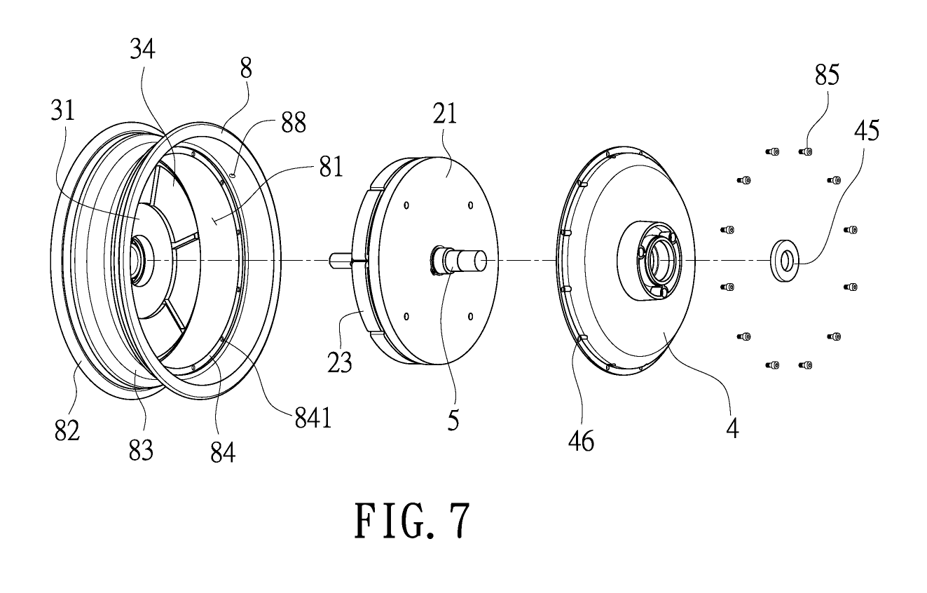

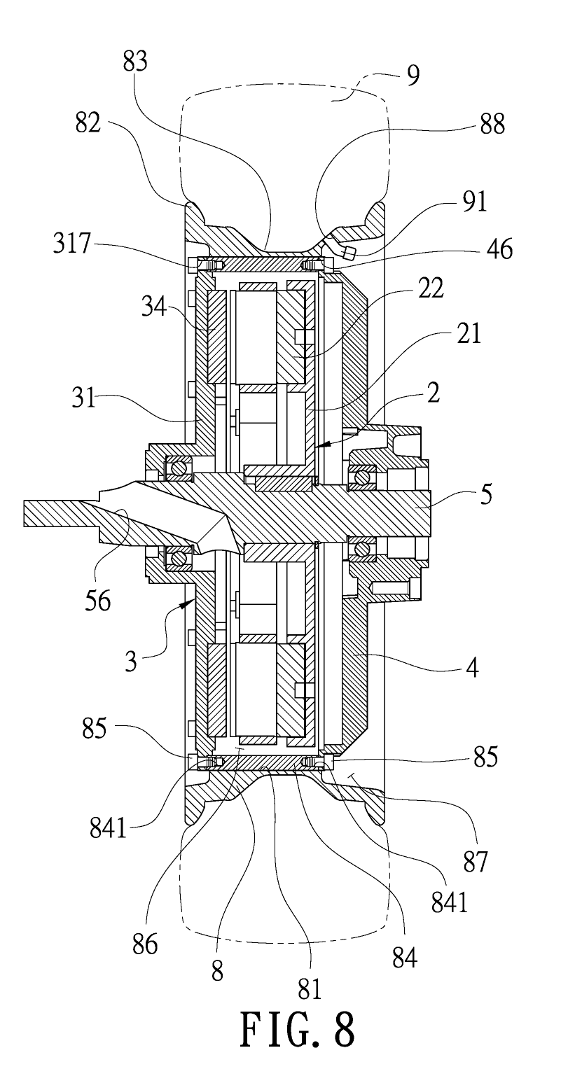

Referring to FIG. 7 and FIG. 8, a second embodiment for a wheel hub motor according to the present invention is disclosed. A ring-shaped casing (8) comprises a first end, a second end opposite to the first end, a cavity (81) at a center thereof, two outer flanges (82) respectively disposed at the first end and the second end, a wheel assembling part (83) disposed between the two outer flanges (82), a fixing ring (84) on a wall of the cavity (81) to be connected to the wall of the cavity (81), plural fasteners (85), an enclosed region (86) defined by the rotor base (31) and the shell cover (4), an open region (87) defined by the cavity (81) at the first end thereof and the shell cover (4), and an air hole (88) penetrating the wheel assembling part (83) and the open region (87).

The ring-shaped casing (8) is formed in a wheel frame shape for a tire (9) to be assembled to the wheel assembling part (83). The fixing ring (84) has a first end spaced apart from the first end of the ring-shaped casing (8) and a second end extended from the second end of the ring-shaped casing (8). The fixing ring (84) has a first end, a second end opposite to the first end, plural lock holes (841) respectively disposed at the first end and the second end. The plural fasteners (85), e.g. screws, are used for locking the plural lock holes (317) of the rotor base (31) to the plural lock holes (841) at the second end of the fixing ring (84) for fixation and for locking the plural lock holes (46) at the periphery of the shell cover (4) to the plural lock holes (841) at the first end of the fixing ring (84). The plural permanent magnetic sheets (34) disposed on the stator unit (2) and the rotor unit (3) are accommodated in the enclosed region (86). A gas nozzle (91) of the tire (9) is inserted from the wheel assembling part (83) through the air hole (88) into the open region (87).

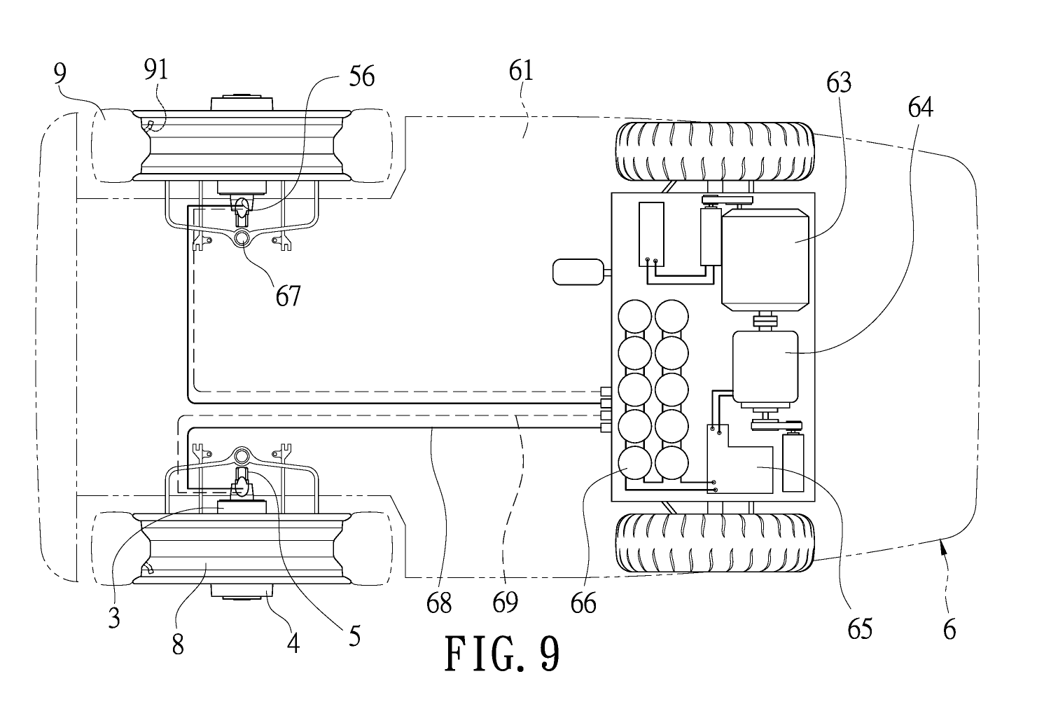

Accordingly, in a practical use of the present invention as shown in FIG. 9, the two ring-shaped casings (8) of the two wheel hub motors formed in wheel frame shapes are provided with the tires (9) and directly installed at the rear side of the car body (61) for use as the two wheels (62) without the need to assemble the wheel frames (621) of the two wheels (62). Therefore, the cost and working hours of assembling the wheel frames (621) can be saved.

The forgoing embodiments and figures are not intended to limit the modes of the invention. In this invention, the wheel hub motor can be installed in the two wheels (62) at the rear side of the car body (61) of the vehicle (6) or at the front side of the car body (61) of the vehicle (6) to provide two-wheel drive for the general vehicle (6). Furthermore, two wheel hub motors also can be respectively installed in the two wheels (62) at the front side and installed in the two wheels (62) at the rear side of the car body (61). The capacitive battery (66) is connected to the two wheel hub motors respectively installed in the two wheels (62) at the front side and the rear side of the car body (61) by the power cable (68) to provide the four-wheel drive vehicles, such as off-road vehicles and chariots for use. Furthermore, the gasoline engine (63), the electricity generator (64), the power and motor controller (65) and the capacitive battery (66) also can be replaced by general batteries, and a plurality of batteries are assembled to be a power supply unit and further connected to the wheel hub motors by the power cable (68).

According to the above description, in comparison with the traditional technique, the wheel hub motor according to the present invention has the advantages as following:

1. The present invention comprising the plural permanent magnetic sheets which are disposed on the rotor base and corresponding to the stator ring increases the sensing area of the plural permanent magnetic sheets and the stator ring and thereby achieves the effects of providing large torque and horsepower of the wheel hub motor.

2. The stator ring of the present invention is made of a long silicon steel strip and wound and tightly fixed into a ring body, so that the stator ring has high structural strength after molding and prevents disadvantage of locking plural silicon steel strips to the stator unit one by one with screws, which save time and increase convenience in assembly.

3. The present invention comprises plural minimal ditches only at the second side of the stator ring, so the air spaces are reduced, and the magnetic flux and the magnetic effect are improved. In the case of an increase in the magnetic effect and an increase in the sensing area, the same electric voltage and current can be used to obtain several times of torque and horsepower, so the present invention saves the energy and improves the endurance of the vehicle.

4. The motor commutation control element of the present invention detects the change of the magnetic field strength and the rotating speed of the rotor unit when operating and further adjusts the voltage of the coils, so the present invention can be operated smoothly and efficiently.

5. The ring-shaped casing of the present invention formed in a wheel frame shape can replace the wheel frame of the wheel for use, so the cost and working hours of assembling the wheel frames can be saved.

6. The present invention comprising plural fixing slots on the rotor base reduces the amount of glue used to bond the plural permanent magnetic sheets, and the permanent magnetic sheets firmly and evenly connect the plural fixing slots after a pressure is applied, so the present invention improves the convenience of assembling the permanent magnetic sheets and avoids the dirt caused by the overflow of the glue.

What is claimed is:

1. A wheel hub motor, comprising:
a ring-shaped casing having a first end, a second end opposite to the first end and a cavity at a center thereof;
a stator unit having a stator base, a stator ring and plural coils, wherein the stator base has a first side, a second side opposite to the first side, a shaft sleeve at a center of the second side thereof for assembling to the stator ring, and a shaft hole at a center of the shaft sleeve, and wherein the stator ring is formed by a wound silicon steel sheet tightly integrated into one and provided with a through hole concentric with the shaft hole of the stator base, plural coil holes arranged at intervals therein and being wrapped around with one of the plural coils between the two adjacent coil holes thereof, and plural ditches respectively corresponding to the plural coil holes for communicating with the plural coil holes;
is a rotor unit having a first side, a second side opposite to the first side, a rotor base for correspondingly covering at the second end of the ring-shaped casing for connection and plural permanent magnetic sheets disposed on the first side of the rotor base and accommodated in the cavity of the ring-shaped casing for corresponding to the stator ring, wherein the rotor base has a shaft hole at a center thereof and plural fixing slots arranged at intervals thereon and concentric with the shaft hole to be correspondingly and respectively assembled with the plural permanent magnetic sheets;
a shell cover covered at the first end of the ring-shaped casing for connection and having a shaft hole at a center thereof; and
a major axis accommodated in the cavity of the ring-shaped casing and inserted into the shaft hole of the stator base, the shaft hole of the rotor base and the shaft hole of the shell cover for fixing to the stator base.

2. The wheel hub motor as claimed in claim 1, wherein the ring-shaped casing is provided with a fixing ring on a wall of the cavity to be connected to the wall of the cavity and having a first end extended from the first end of the ring-shaped casing for connecting the shell cover and a second end extended from the second end of the ring-shaped casing for connecting the rotor base.

3. The wheel hub motor as claimed in claim 1, wherein the ring-shaped casing is furthered with two outer flanges respectively at the first end and the second end thereof, a wheel assembling part disposed between the two outer flanges, a fixing ring on a wall of the cavity to be connected to the wall of the cavity and having a first end spaced apart from the first end of the ring-shaped casing for connecting the shell cover and a second end extended from the second end of the ring-shaped casing for connecting the rotor base, an enclosed region defined by the rotor base and the shell cover to accommodate the plural permanent magnetic sheets disposed on the stator unit and the rotor unit, an open region defined by the cavity at the first end thereof and the shell cover, and an air hole penetrating the wheel assembling part and the open region.

4. The wheel hub motor as claimed in claim 1, wherein the rotor unit comprises the rotor base having the first side connected to the ring-shaped casing, the second side opposite to the first side, a first assembling part at the center of the first side thereof, a second assembling part at the center of the second side thereof, a first assembling slot at a center of the first assembling part, a second assembling slot at a center of the second assembling part and a shaft hole at the center thereof for penetrating the first assembling part and the second assembling part, at least one bearing accommodated in the first assembling slot and a sealing ring engaged with the second assembling slot, wherein the shell cover comprises a first side, a second side opposite to the first side for connecting the ring-shaped casing, a third assembling part at a center of the first side thereof and having a third assembling slot at a center thereof, a fourth assembling part at a center of the second side thereof and having a fourth assembling slot at a center thereof, the shaft hole at the center thereof, at least one bearing accommodated in the fourth assembling slot, and a sealing ring engaged with the third assembling slot, and wherein the major axis comprises a first end for inserting into the shaft hole of the stator base and the shaft hole of the shell cover for connecting the at least one bearing in the fourth assembling slot and the sealing ring in the third assembling slot, and a second end opposite to the first end for inserting into the shaft hole of the rotor base for connecting the at least one bearing in the first assembling slot and the sealing ring in the second assembling slot and protruding from the second end of the rotor base.

5. The wheel hub motor as claimed in claim 4, wherein the major axis further comprises a first segment having a first side and a second side opposite to the first side for contacting the at least one bearing in the first assembling slot of the rotor base for positioning, a buckle ring engaged with the first side of the first segment and contacting the first side of the stator base for positioning, and a second segment adjacent to the buckle ring for contacting the at least one bearing in the fourth assembling slot of the shell cover for positioning, and wherein the shaft sleeve is formed on the second side of the stator base for contacting the first side of the first segment for positioning.

6. The wheel hub motor as claimed in claim 4, wherein the third assembling part of the shell cover further comprises plural lock bores at a periphery of the third assembling slot.

7. The wheel hub motor as claimed in claim 1, wherein the stator base further comprises a first positioning part on a wall of the shaft hole, and the major axis further comprises a second positioning part corresponding to the first positioning part and a fixing element for fixedly connecting the second positioning part with the first positioning part.

8. The wheel hub motor as claimed in claim 1, wherein the stator base further comprises an engaging slot surrounding the shaft sleeve at the second side thereof for correspondingly engaging with the stator ring.

9. The wheel hub motor as claimed in claim 1, wherein the major axis further comprises a cable outlet hole formed lengthwise at the second end thereof and having one opening located in the cavity of the ring-shaped casing and the other opening located out of the rotor base.

10. The wheel hub motor as claimed in claim 1, further comprising at least one motor commutation control element disposed at a periphery of the or disposed on the major axis adjacent to the rotor base.
